(19) United States
(12) Patent Application Publication
(10) Pub. No.: US 2006/0215820 A1
(43) Pub. Date: Sep. 28, 2006

(54) Method for ending long duration calls

(76) Inventors: Deborah Lewandowski Barclay, Winfield, IL (US); David S. Benco, Winfield, IL (US); Sanjeev Mahajan, Naperville, IL (US); Thomas Lee McRoberts, Naperville, IL (US); Raymond Leroy Ruggerio, Glenview, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/088,588

(22) Filed: Mar. 24, 2005

(51) Int. Cl. H04M 3/08; H04M 3/22

(52) U.S. Cl. 379/32.04

(57) ABSTRACT

The present invention provides a method for ending a call after a predetermined duration. A subscriber sets a call duration. When the call duration has been exceeded, the subscriber is alerted and the call is ended. The subscriber can, upon entering a feature code or a personal identification number (PIN), override the ending of the call.

### FIELD OF THE INVENTION

The present invention relates generally to communication systems, and more particularly to ending calls in a communication system.

### BACKGROUND OF THE INVENTION

Wireless and wireline communication systems provide subscribers with the ability to communicate with other subscribers. In wireline communication systems, users often pay per minute, especially for long-distance phone calls. Similarly, wireless subscribers typically pay for each minute of call time that they use.

One problem associated with billing in communication systems is that subscribers are charged as long as the call is ongoing, even if the user thinks that the call has ended. For example, a wireline user may think that the wireline phone has been replaced properly in the based unit, but if the phone is misaligned, the switch hook may not be triggered and the call may not be ended. Also, if a wireline subscriber answers or places a call using a first phone but then switches to a second phone, the first phone may not be hung up. In this case, even when the second phone is hung up, the call is not ended immediately, due to the first phone remaining off hook. And young children may pick up a phone and randomly hit buttons on the phone, thereby placing a call, perhaps even a long-distance or international call. The child may then set the phone down without hanging up, thereby incurring charges for calls that were never intended by the subscriber.

Another problem for subscribers in pay-for-usage communication systems is that a subscriber can lose track of time and end up involved in a call for a much longer period than originally anticipated. Further, it is sometimes difficult to tell a party that you are communicating with that it is time to end the call, even though the call has become cost-prohibitive.

A further issue in current communication systems is that children are given cellular phones for safety reasons, but end up using the cellular phones for reasons other than their own personal safety. Parents may not be aware of this, and may be surprised when they receive a monthly usage charge that is significantly costlier than expected.

Therefore, a need exists for a method for ensuring that calls are not unnecessarily continued when a subscriber desires them to be finished. Further, a need exists for a method for ensuring that calls placed on subscriber phones do not extend beyond the subscriber's desires.

### BRIEF SUMMARY OF THE INVENTION

The present invention provides a method for ending long duration calls. In an exemplary embodiment of the present invention, a call is set up. The call can involve a wireline or a wireless subscriber, and can be placed by the subscriber or can be intended for the subscriber.

The communication system determines whether the call duration feature is enabled. In an exemplary embodiment, the call duration feature allows a subscriber to subscribe to a feature that permits them to set a maximum call duration. The maximum call duration is preferably utilized for all calls placed to or from the subscriber phone. The default maximum call duration can be changed or overridden by the subscriber on a per-call basis. The subscriber can configure the call duration feature such that the default condition is that to activate the call ending feature, or the default can be to not activate the call duration timer. The call duration feature can be configured so that it applies to all calls to or from the subscriber, only to long-distance calls, or only to international calls. If the call duration feature is not enabled, the process end and typical call processing occurs for the call.

If the call duration feature is enabled, the communication system determines if the call duration has been exceeded. If the call duration has not been exceeded, the process continues and the call will again be checked to determined if the call duration has been exceeded.

If the call duration has been exceeded, the communication system determines if the user can override the exceeding of the call duration. In certain circumstances, the subscriber may want to disregard the default call ending.

The subscriber can preferably override the call duration feature by entering a feature code or personal identification number (PIN) into the phone. Further, the subscriber can preferably change the maximum call duration value for the current call.

If the user overrides the call duration feature, the call continues. If the user does not override the call duration feature, the communication system ends the call. The communication system preferably alerts the subscriber that the call duration has been exceeded and that the call is about to end. The communication system preferably gives the subscriber a short amount of time, such as ten seconds, to wrap up the call with the other party prior to disconnecting the call.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for ending long duration calls in accordance with an exemplary embodiment of the present invention.

### DETAILED DESCRIPTION OF THE INVENTION

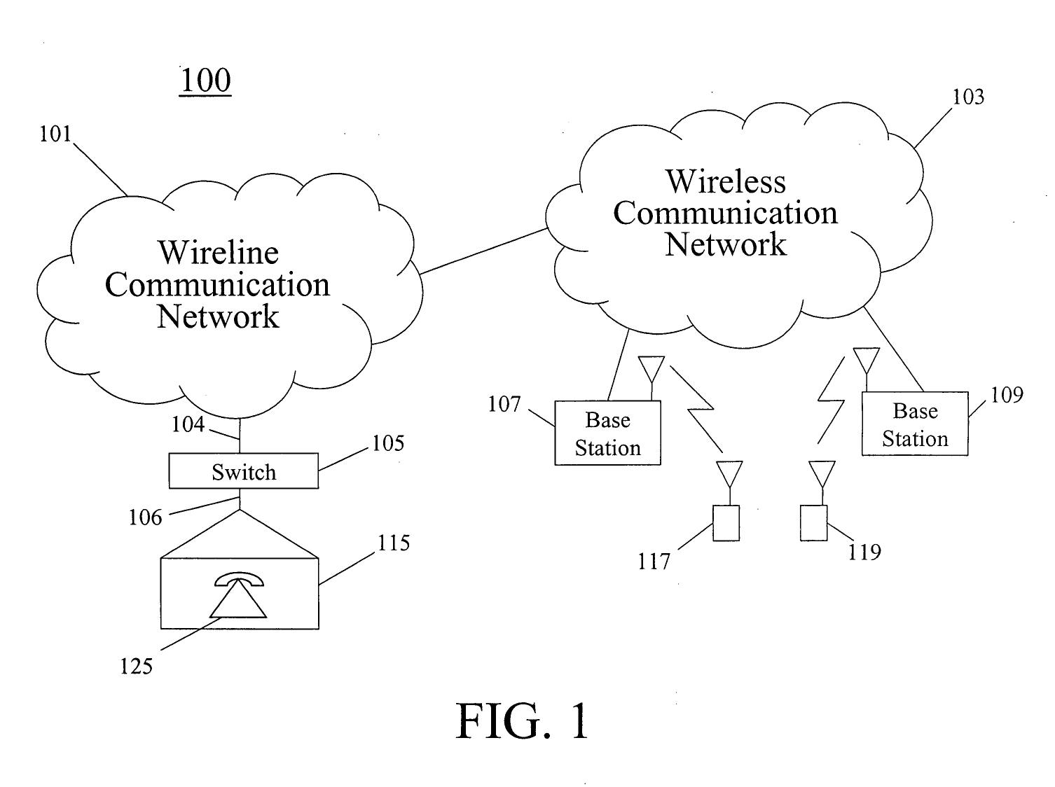

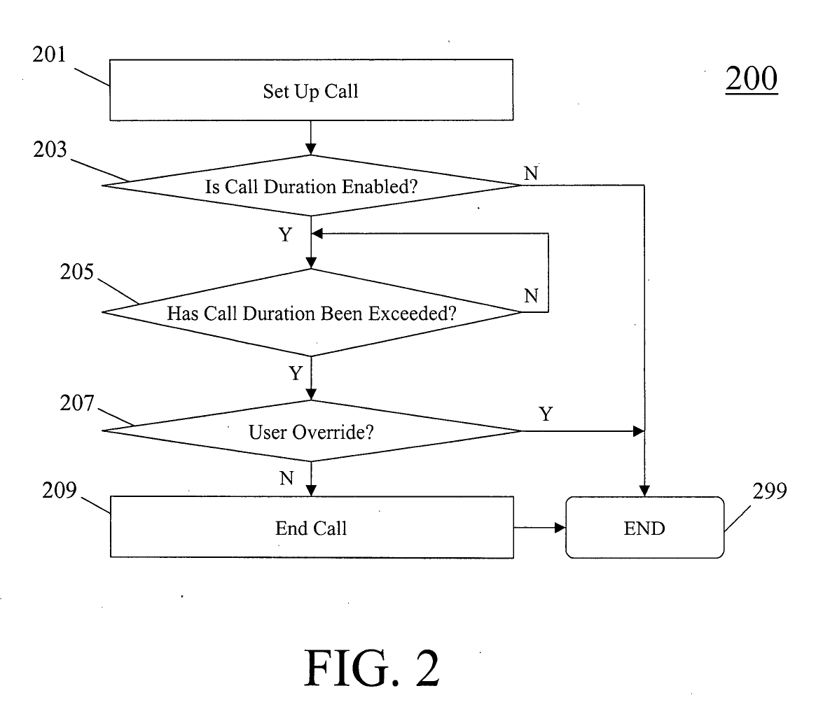

The present invention can be better understood with reference to FIGS. 1 and 2. FIG. 1 depicts a communication system 100 that includes a wireline communication network 101, a wireless communication network 103, switch 105, and base stations 107 and 109.

Wireline communication network 101 is preferably a public switched telephone network (PSTN). Wireline communication network 101 provides communication to a plurality of wireline users, only one of which, CPE 125, are depicted for clarity.

Switch 105 is connected to wireline communication network 101 via line 104. In a preferred embodiment, there are a plurality of switches connected to wireline communication network 101, and each of the plurality of switches provide access for a plurality of CPEs to wireline communication network 101. In an exemplary embodiment of the present invention, switch 105 is a 5ESS SWITCH provided by LUCENT TECHNOLOGIES INC.

Premises 115 is typically a house or other building, such as an office building, school, church, or any other building that is connected to PSTN 101 by switch 105. In an exemplary premises, a single communication line 106 runs to premises 115 from switch 105. For CPEs connected to a phone line, the CPEs are able to participate in the same call. If one of the CPEs is left off-hook after a call ends, however, not only is the off-hook CPE unable to make or receive a call, but all other CPEs connected to the same phone line are prevented from making or receiving calls.

FIG. 2 depicts a flowchart 200 of a method for ending long duration calls in accordance with an exemplary embodiment of the present invention.

In an exemplary embodiment of the present invention, a call is set up (201). The call can involve a wireline or a wireless subscriber. Further, the call can be placed by the subscriber or can be intended for the subscriber.

The communication system determines (203) whether the call duration feature is enabled. In an exemplary embodiment, a subscriber subscribes to a feature that allows them to set a maximum call duration. This maximum call duration is preferably utilized for all calls placed to or from the subscriber. In an exemplary embodiment, the default maximum call duration can be changed or overridden by the subscriber on a per-call basis. The subscriber can configure the call duration feature such that the default condition is that to activate the call ending feature, or the default can be to not activate the call duration timer. The call duration feature can be configured so that it applies to all calls to or from the subscriber, only to long-distance calls, or only to international calls. If the call duration feature is not enabled, the process end (299) and typical call processing occurs for the call.

If the call duration feature is enabled as determined at step 203, the communication system determines (205) if the call duration has been exceeded. In an exemplary embodiment, this determination occurs as the result of the expiration of a timer that was set to the default maximum call duration at the time the call began. If the call duration has not been exceeded, the process continues and the call will again be checked to determined if the call duration has been exceeded.

In an exemplary embodiment of the present invention, a warning indicator is sent to the subscriber. The warning indicator alerts the user that the predetermined call duration timer has expired, and that the call will be ended shortly unless intervention occurs by the user.

If the call duration has been exceeded as determined at step 205, the communication system determines (207) if the user can override the exceeding of the call duration. In certain circumstances, the subscriber may want to disregard the default call ending. For example, the call may be important enough that the subscriber is willing to exceed their own predetermined call length limit. In a further example, the subscriber may have the call duration feature intended for a son or daughter, and may therefore not want the call duration feature to end calls made or received by the subscriber.

In an exemplary embodiment, the subscriber overrides the call duration feature by entering a feature code into the phone. For example, the subscriber may enter a feature code such as *23 to override the call duration feature. The user may be required to enter a personal identification number (PIN) in order to inactivate the call duration feature. In a further exemplary embodiment, the subscriber can change the maximum call duration value for the current call. In this embodiment, the subscriber enters a feature code, followed by a new value for the maximum call duration. The entering of the feature code can be done prior to placing the call, or upon expiration of the call duration feature timer.

If the user overrides the call duration feature as determined in step 207, the process ends (299) and the call continues. If the user does not override the call duration feature, the communication system ends (209) the call. In an exemplary embodiment, the communication system alerts the subscriber that the call duration has been exceeded and that the call is about to end. In an exemplary embodiment, the communication system automatically disconnects the call upon the expiration of the call timer and after warning the subscriber. The communication system preferably gives the subscriber a short amount of time, such as ten seconds, to wrap up the call with the other party prior to disconnecting the call.

The alert is preferably sent to the subscriber via an out-of-band signaling technology available to the particular communication technique being used. For example, the alert can be via an in-band tone. In a wireless communication system, the alert can be accomplished using an out-of-band signaling technique such as SMS (Short Message Service). For calls controlled with SIP, SIP signaling can be used to alert the subscriber.

The present invention thereby provides a method for ending a call after a predetermined duration, thereby saving subscribers the costs associated with overly long calls. Further, the present invention ends calls that the user believes have been ended, but have inadvertently been left active, such as when a phone has been left off hook or a cell phone call has not been properly ended. By ending the call after a predetermined call duration, calls can be ended in a timely and cost-effective manner and in a gracious way, without hurting the feelings of the other party involved in the call. The present invention also allows parents to set call limits on calls placed by their children, thereby saving money, especially on cell phones and long-distance calls that charge a fee on a per-minute basis.

While this invention has been described in terms of certain examples thereof, it is not intended that it be limited to the above description, but rather only to the extent set forth in the claims that follow.

We claim:

1. A method for ending a call comprising:
determining that a call duration feature is enabled for a subscriber involved in a call, the call duration feature including a call duration;
determining if the call duration has been exceeded; and
if the call duration has been exceeded, ending the call.

2. A method for ending a call in accordance with claim 1, the method further comprising the step of alerting the subscriber prior to ending the call.

3. A method for ending a call in accordance with claim 2, wherein the step of alerting the subscriber comprises sending a Short Message Service (SMS) message to the subscriber.

4. A method for ending a call in accordance with claim 2, wherein the step of alerting the subscriber comprises sending an Instant Message (IM) to the subscriber.

5. A method for ending a call in accordance with claim 2, wherein the step of alerting the subscriber comprises sending an out-of-band signaling message to the subscriber.

6. A method for ending a call in accordance with claim 2, wherein the step of alerting the subscriber comprises sending an in-band tone to the subscriber.

7. A method for ending a call in accordance with claim 2, wherein the step of alerting the subscriber comprises sending a SIP signaling message to the subscriber.

8. A method for ending a call in accordance with claim 1, the method further comprising the step of overriding the ending of the call.

9. A method for ending a call in accordance with claim 8, wherein the step of overriding the ending of the call comprises overriding the ending of the call during call setup.

10. A method for ending a call in accordance with claim 8, wherein the step of overriding the ending of the call comprises overriding the ending of the call after wherein overriding occurs after the call duration has been exceeded.

11. A method for ending a call in accordance with claim 8, wherein the step of overriding the ending of the call comprises entering a personal identification number (PIN) to override the ending of the call.

12. A method for ending a call in accordance with claim 8, wherein the step of overriding the ending of the call comprises entering a feature code to override the ending of the call.

13. A method for ending a call in accordance with claim 1, wherein the step of determining that a call duration feature is enabled comprises determining that the call duration feature is enabled for all calls to or from the subscriber.

14. A method for ending a call in accordance with claim 1, the method further comprising the step of changing the call duration.

15. A method for ending a call in accordance with claim 1, wherein the step of determining that a call duration feature is enabled comprises determining that the call duration feature is enabled only for outgoing calls of the subscriber.

16. A method for ending a call in accordance with claim 1, wherein the step of determining that a call duration feature is enabled comprises determining that the call duration feature is enabled only for incoming calls to the subscriber.

17. A method for ending a call in accordance with claim 1, wherein the step of determining that a call duration feature is enabled comprises determining that the call duration feature is enabled only for long-distance calls from the subscriber.

18. A method for ending a call in accordance with claim 1, wherein the step of determining that a call duration feature is enabled comprises determining that the call duration feature is enabled only for international calls from the subscriber.

19. A method for ending a call in accordance with claim 1, wherein the step of ending the call comprises giving the subscriber a period of time to complete the call prior to ending the call.
